(19) United States
(12) Patent Application Publication
(10) Pub. No.: US 2023/0410264 A1
(43) Pub. Date: Dec. 21, 2023

(54) REDUCTION OF ARTEFACTS IN A CONE BEAM COMPUTED TOMOGRAPHY

(71) Applicant: KONINKLIJKE PHILIPS N.V., EINDHOVEN (NL)

(72) Inventors: ROLF DIETER BIPPUS, HAMBURG (DE); THOMAS KOEHLER, NORDERSTEDT (DE); KEVIN MARTIN BROWN, CHARDON, OH (US)

(21) Appl. No.: 18/033,882

(22) PCT Filed: Oct. 26, 2021
(86) PCT No.: PCT/EP2021/079623

§ 371 Date: May 4, 2023

Related U.S. Application Data
(60) Provisional application No. 63/109,796, filed on Nov. 4, 2020.

(51) Int. Cl. G06T 5/00; G06T 5/50

(52) U.S. Cl. CPC G06T 5/005; G06T 5/50; G06T 2207/10081; G06T 2207/10112; G06T 2207/30004

(57) ABSTRACT

The present invention relates to a method and a cone beam computed tomography apparatus for reducing artefacts in an image acquired with the cone beam computed tomography apparatus using a second pass artefact reduction method. Projection data of an object are acquired, wherein the projection data comprises a first subset of data to be used for reconstruction of a first image, and a second subset of data comprising projection data not to be used for the construction of the first image, wherein the second subset of data comprises projection data not comprised in the first subset of data. A first and a second image are reconstructed using the first and the second subset of data, respectively. A second pass artefact reduction method is performed using the second image as input image of the second pass artefact reduction method, thereby reducing artefacts in the first image.

### FIELD OF THE INVENTION

The present invention relates to a method for reducing artefacts in an image acquired with a cone beam computed tomography apparatus using a second pass artefact reduction method, and a cone beam computed tomography apparatus for reducing artefacts in an image using a second pass artefact reduction.

### BACKGROUND OF THE INVENTION

A promising solution for the reduction of artefacts in cone-beam computed tomography (CT) applications is the so-called second pass method, in which artefacts are estimated by simulating the cone-beam computed tomography acquisition and image reconstruction using as input some image derived from the initially reconstructed image. However, the input image to the second pass method is derived from an image that contains exactly those artefacts that are to be removed. Thus, the second pass method will provide only a crude estimate of the true artefact inducing structures in the image. The simulation will give optimal results for the input being the already perfectly corrected, true image. However, this is not available and experience shows that the initial reconstruction with the cone-beam artefacts being present cannot be used directly for the second pass correction. Thus, it has been suggested to process the initial reconstruction such that just the artefact inducing structures are maintained. The second pass input image needs to contain a good estimation of the true gradients in z-direction parallel to the rotation axis. An adaptive thresholding operation on the image values can be used to obtain this image, which can also be performed iteratively. Other methods include an image domain filtering, fusion and reverse filtering of two differently reconstructed images.

The inventors of the present invention have thus found that it would be advantageous to have a method and a cone beam computed tomography apparatus for reducing artefacts in an image using a second pass artefact reduction that improves cone-beam CT artefact reduction via a second pass artefact estimation.

### SUMMARY OF THE INVENTION

It is an object of the present invention to provide a method and a cone beam computed tomography apparatus for reducing artefacts in an image using a second pass artefact reduction that provides reliable reduction of artefacts in the reconstructed image and thus offers a high quality image of an object to be imaged.

The object of the present invention is solved by the subject matter of the independent claims, wherein further embodiments are incorporated in the dependent claims.

The described embodiments similarly pertain to the method for reducing artefacts in an image acquired with a cone beam computed tomography apparatus using a second pass artefact reduction method, and the cone beam computed tomography apparatus for reducing artefacts in an image using a second pass artefact reduction. Synergistic effects may arise from different combinations of the embodiments although they might not be described in detail.

Further on, it shall be noted that all embodiments of the present invention concerning a method might be carried out with the order of the steps as described, nevertheless this has not to be the only and essential order of the steps of the method. The herein presented methods can be carried out with another order of the disclosed steps without departing from the respective method embodiment, unless explicitly mentioned to the contrary hereinafter.

According to a first aspect of the invention, there is provided a method for reducing artefacts in an image acquired with a cone beam computed tomography apparatus using a second pass artefact reduction method. The method comprises the step of acquiring of projection data of an object to be imaged with the cone beam computed tomography apparatus, wherein the projection data comprises a first subset of data to be used for reconstruction of a first image, and a second subset of data comprising projection data not to be used for the construction of the first image, wherein the second subset of data comprises projection data not comprised in the first subset of data. The method comprises further the steps of reconstructing a first image comprising a first resolution using the first subset of data of the projection data, reconstructing a second image comprising a second resolution using the second subset of data of the projection data, and performing the second pass artefact reduction method using the second image as input image of the second pass artefact reduction method, thereby reducing artefacts in the first image.

A modified second pass method for correcting artefacts in computed tomography images is proposed, especially employing wide cone angles. The method makes favorable use of the fact, that regularly, in addition to the data used for reconstruction of the first image, additional data can be acquired. Thus, e.g. prior to a purely axial perfusion scan, a helical native scan can be performed, covering a larger part of the anatomy than the actual scan. The image resulting from such a scan therefore can contain information on anatomical, artefact inducing structures, which cannot be fully recovered from purely axial perfusion scans. These images from prior scans can be used as additional input to a second pass method to improve the estimation of cone beam artefacts. Also in prospectively gated cardiac scans typically more projection data than absolutely necessary can be acquired, e.g. due to cardiac phase tolerances, which can be favorably explored to improve the second pass method as known in the art.

According to the invention, the first data set comprises data that are used for reconstructing a first image of the object to be imaged. This first image can be a three dimensional reconstruction of the anatomy of a patient. However, this first image can comprise artefacts, for example due to beam hardening effects, that result in a disturbed image of the object, preventing a clear analysis of the image by a physician. Thus, the second subset of data is used to reconstruct a second image. This second subset of data can be acquired in addition to the first subset of data or can be additional data acquired that is not used for reconstruction of the first image, and used either alone or in conjunction with the first subset of data to reconstruct the second image depending on the imaging method. This additional data can comprise information about the object to be imaged that are not comprised in the first subset of data. However, there can be projection data available that are comprised in the first subset of data as well as in the second subset of data. At least a part of the projection data of the second subset of data is not comprised in the first subset of data and is not used for reconstruction of the first image. Thus, the second image reconstructed from the second subset of data can provide more detailed information about the object to be imaged, in particular about the presence and position of artefact inducing structures. These artefact inducing structures can be structures with a high absorption density with respect to X-ray radiation, and in particular regions of the object to be imaged with a high gradient of the absorption density in the axial direction of the computed tomography apparatus. This axial direction can be defined by the axis of rotation of the X-ray anode and the X-ray detector. By performing the second pass correction method with the second image as input image, an improved and more detailed correction of the artefacts can be achieved. Therefore, the method according to the invention can provide a better reduction of artefacts depicted in the first image.

Compared to the second pass method as known from the art, some major problems can be identified that are overcome by the proposed solution. The input image to the second pass method no more derived from an image that contains exactly those artefacts which are to be removed. The proposed method aims at providing a better second pass input image with less artefacts compared to the first pass. Thus, the invention suggests an improved second pass artefact estimation method by leveraging from additional acquisition data acquired during or before the actual scan, which typically have more projection data than necessary. The invention proposes using images from prior scans as additional input to the second pass method to improve the estimation of cone beam artefacts.

In an embodiment of the invention, the second subset of data comprises projection data from a region of the object that is not comprised in the first subset of data, or the second subset of data comprises projection data of the object from a projection direction not comprised in the first subset of data.

Projection data from a region of the object not comprised in the first subset of data can be, for example, data covering a larger field of view of the image. Thus, for example, the extent of the second subset of data in the z-direction parallel to a rotational axis of the computed tomography apparatus can be larger. Alternatively, the second subset of data can comprise projection data from additional projection directions. These projection directions can, for example, comprise projection angles covering a range larger than 180°.

In an embodiment of the invention, the second pass artefact reduction method comprises the steps of determining an artefact-inducing structure in the input image, forward-projecting the artefact-inducing structure into forward projection data, reconstructing an artefact image using the forward projection data, combining the artefact image with a low pass filtered image of the artefact-inducing structure thereby generating a correction image, and combining the correction image with the first image thereby reducing artefacts in the first image.

Thus, the second image reconstructed from the second subset of data is used as input image for the second pass artefact reduction method. By applying a threshold to the input image, artefact inducing structures can be determined. These artefact inducing structures are forward projected resulting in virtual projection data that would have been detected by the computed tomography apparatus when imaging a phantom only comprising the artefact inducing structures. These virtual projection data are processed in order to reconstruct an image of the artefact inducing structures, for example by a filtered back projection. Therefore, this reconstructed image comprises, in addition to the reconstructed artefact inducing structures, the artefacts induced by the artefact inducing structures. By combining this artefact image with low-pass filtered data of the image of the artefact inducing structures, the artefacts can be isolated. This correction image only comprising the artefacts can be subtracted, preferably after appropriate registration and adjustment of the contrast, from the first image. Thus, a high-quality image of the first image depicting the object to be imaged can be provided without being deteriorated by artefacts. Alternatively, a gradient image in axial direction is calculated from the input image and thresholding is performed on the gradient image keeping only large gradients above the threshold. After thresholding, integration can be performed in axial direction and the result can be used as input for the second pass method. Using the input image without axial differentiation can be done in the original second pass method and might need a tissue classification using one or more thresholds, possibly along with the image based determination of optimal tissue absorption values, depending on the classification.

In an embodiment of the invention, the artefact-inducing structure comprises a high absorption density gradient in a direction parallel to a rotation axis of the computed tomography apparatus.

The rotation axis of the computed tomography apparatus is defined by the rotation of the X-ray source and the X-ray detector around this axis. In particular in cone beam CTs, a high gradient of the X-ray absorption of the material of the object in the direction parallel to the rotation axis may lead to artefacts in the image. This may be the case especially if the structure comprising the high density gradient is in or beyond the border area of the coverage, in particular the axial coverage, of the X-ray imaging apparatus.

In an embodiment of the invention, the second pass artefact reduction method comprises the step of up-sampling the correction image to a resolution equal to the first resolution of the first image.

The correction image can comprise a resolution different from the first resolution of the first image. Thus, in order to subtract the image comprising the artefacts from the first image, the resolution of the correction image can be adapted to match the resolution of the first image.

In an embodiment of the invention, the second subset of data comprises data acquired in a second scan prior to a brain perfusion scan, or wherein the second subset of data comprises data acquired due to cardiac phase tolerances in a gated cardiac scan.

For example, in case a perfusion scan is performed, prior to the perfusion scans, e.g. helical native scans can be performed, covering a larger part of the anatomy. The image resulting from such a scan therefor contains information on anatomical, artefact inducing structures, which cannot be fully recovered from purely axial perfusion scans. Especially in Brain perfusion, a native scan is needed as reference scan. Additionally, a CTA is performed, that includes the brain and at least parts of the neck. Both scans are/can be performed in helical scan mode, providing images that should be free of cone beam artefacts, less noisier and most important, can contain artefact inducing structures beyond the axial coverage of the axial perfusion scan. It can thus serve much better as input to the second pass method compared to the individual time series perfusion scans.

In another example, in case of gated cardiac scans, the input image to the second pass estimation of the artefacts can be replaced by an image that is not the image as it is originally reconstructed (cardiac field of view (FOV), gated reconstruction with frequency split). Rather it is a full FOV image obtained from a full FOV reconstruction using all data available. Cone-beam artefacts can also be created by structures outside the field-of-view that is initially reconstructed. In this case, field-of-view may refer mainly to the in-plane field-of-view, and only to a small extent to the axial coverage. In this embodiment of the invention, the axial coverage may be approximately the same for the first image and the second image. These artefact inducing structures outside the limited field-of-view may be a problem in full scan axial CT and may be even worse in cardiac CT where a short scan reconstruction is needed. Thus, the input image to the second pass estimation uses full-scan data in order to maximize the z-extent of the input image, thus capturing as much of the artefact inducing structures as possible.

In an embodiment of the invention, the second scan is a helical scan.

The second scan performed prior to the perfusion scan can be a helical scan. Thus, the X-ray source as well as the X-ray detector of the computed tomography apparatus can be moved along the rotation axis during the rotational movement of X-ray source and X-ray detector. Alternatively, the second scan can be performed after the perfusion scan. In the second scan, projection data can be acquired comprising a larger volume of the object to be imaged, in particular in the direction of the rational axis, which can be the z-direction. The second scan can be a native scan.

In an embodiment of the invention, a second image contrast of the second image is adjusted to match a first image contrast of the first image.

In order to combine the correction image with the first image to correct for artefacts, the image contrast of the first image and the correction image have to be adapted to each other. Therefore, the artefacts can be correctly compensated for. For adjusting the contrast, the contrast of the first image, the second image and also the correction image can be adapted.

In an embodiment of the invention, the second image is registered to the first image.

Registration of the first image and the second image may be necessary to receive a correct subtraction of the artefacts in the first image. Thus, pixels of the second image have to be at the same position of the respective pixel of the first image. However, also the correction image can be registered to the first image. Since the skull is a rigid structure, registration of the initial, helical scan to each of the images of a time series of the perfusion scans can be done by registering the clearly depictable structure in each of the images to each other. Provided the position of the radiation source relative to the patient's head does not change, artefacts that have been estimated given a specific source position can be transferred to all images with the same, relative configuration. That is, ideally, to all images of the time series. Performing the registration shown above, the relative system-to-patient configuration can be tracked along the times series to detect changes due to patient motion. Whenever the relative configuration changes significantly, the simulation of the artefacts may have to be repeated instead of doing this for every single image in the time series.

In an embodiment of the invention, reconstructing the second image is performed at a second resolution differing from the first resolution of the first image, or the second image is low-pass filtered and the second resolution of the second image is decreased prior to the step of performing the second pass artefact reduction method.

Due to the simulation that involves a forward projection and a filtered back-projection, the method is computationally expensive. The proposed method aims at reducing the computational burden by performing the second pass method at lower resolution, making use of all the data typically available in a prospectively gated cardiac scan or in helical scan. Especially in perfusion imaging, e.g. of the brain, a time series of images can be acquired, each of which needs to be corrected, involving even more computation. In addition, the individual scans will be deteriorated by noise due to the relatively low allowable dose due to the continuous scanning. Thus, by performing the second pass method at a lower resolution, and optionally up-scaling the correction image to the resolution of the first image, the computational costs of the method for reducing artefacts of the present invention can be decreased.

In an embodiment of the invention, the reconstruction of the first image and/or the reconstruction of the second image comprises a frequency split method.

Another method, the frequency split method, which implies the availability of projection data from an angular range much wider than the necessary 180° plus fan angle, which is typically the case, alone due to the necessary phase tolerance when setting the gating window prospectively. Here, two images are reconstructed from high pass filtered projection data and using a small gating window for reconstruction for fine details, and a reconstruction from low pass filtered projection data and a wide gating widow, ideally making use of all available data. This method assumes that a large part of the cone beam artefacts, especially the short scan artefacts, are relatively low frequency artefacts, however they are much less prominent in the low frequencies of a full axial image.

According to another aspect of the invention, there is provided a cone beam computed tomography apparatus for reducing artefacts in an image using a second pass artefact reduction method. The apparatus comprises an acquisition unit configured for acquiring projection data of an object to be imaged, wherein the projection data comprises a first subset of data to be used for reconstruction of a first image, and a second subset of data comprising projection data not to be used for the construction of the first image, wherein the second subset of data comprises projection data not comprised in the first subset of data. The apparatus further comprises a processing unit configured for reconstructing a first image using the first subset of data of the projection data, configured for reconstructing a second image using the second subset of data of the projection data, and configured for performing the second pass artefact reduction method using the second image as input image of the second pass artefact reduction method, thereby reducing artefacts in the first image.

The computed tomography apparatus comprises an acquisition unit and a processing unit. The acquisition unit is configured for acquiring the projection data of an object to be imaged. These projection data are divided into a first subset and a second subset of projection data. The first subset comprises data necessary for the actual reconstruction of a first image of the object. The second subset of data may be acquired in addition to the data of the first subset of data and may comprise projection data from different angles or a different field of view of the object to be imaged. The second subset of data can comprise additional data acquired that is not used for reconstruction of the first image, and used either alone or in conjunction with the first subset of data to reconstruct the second image. The processing unit can be configured for controlling the data acquisition of the acquisition unit and for reconstructing a first image using the first subset of data and a second image using the second subset of data. Further, the processing unit is configured for performing the second pass artefact reduction method, wherein the second image is used as input image for reducing artefacts in the first image.

In an embodiment of the invention, the processing unit is further configured for determining an artefact-inducing structure in the input image, forward-projecting the artefact-inducing structure into forward projection data, reconstructing an artefact image using the forward projection data, combining the artefact image with a low pass filtered image of the artefact-inducing structure thereby generating a correction image, and combining the correction image with the first image thereby reducing artefacts in the first image.

The processing unit performs the method of reducing artefacts in the first image in this embodiment of the invention. Therefore, the second image is used as input image of the second pass method. Thus, a threshold is applied to the second image for determining artefact inducing structures. These artefact inducing structures are forward projected and back projected to result in an artefact image. By subtracting the previously determined artefact inducing structures, which may be low pass filtered, a correction image can be determined. The correction image containing the artefacts is subtracted from the first image, thus providing an image of the object to be imaged with reduced artefacts. Alternatively, the processing unit can be configured for calculating a gradient image in axial direction from the input image and performing thresholding on the gradient image keeping only large gradients above the threshold. After thresholding, integration can be performed in axial direction and the result can be used as input for the second pass method.

According to another aspect of the invention, there is provided a computer program element, which, when executed on a processing unit, instructs the processing unit to cause the method according to any of the preceding embodiments.

The computer program element can be performed on one or more processing units, which are instructed to cause the method for reducing artefacts in an image acquired with a cone beam computed tomography apparatus using a second pass artefact reduction method.

Preferably, the program element is stored in a computed tomography apparatus for reducing artefacts in an image acquired with a cone beam computed tomography apparatus using a second pass artefact reduction method and a processing unit carrying out this program element is part of said apparatus.

The computer program element may be part of a computer program, but it can also be an entire program by itself. For example, the computer program element may be used to update an already existing computer program to get to the present invention.

The computer program element may be stored on a computer readable medium. The computer readable medium may be seen as a storage medium, such as for example, a USB stick, a CD, a DVD, a data storage device, a hard disk, or any other medium on which a program element as described above can be stored.

According to another aspect of the invention, there is provided a processing unit configured for executing the computer program element according to the preceding embodiment.

The processing unit can be distributed over one or more different devices executing the computer program element according to the invention.

Thus, the benefits provided by any of the above aspects equally apply to all of the other aspects and vice versa.

In a gist, the invention relates to a to a method and a cone beam computed tomography apparatus for reducing artefacts in an image acquired with the cone beam computed tomography apparatus using a second pass artefact reduction method. Projection data of an object are acquired, wherein the projection data comprises a first subset of data to be used for reconstruction of a first image, and a second subset of data comprising projection data not to be used for the construction of the first image, wherein the second subset of data comprises projection data not comprised in the first subset of data. A first and a second image are reconstructed using the first and the second subset of data, respectively. A second pass artefact reduction method is performed using the second image as input image of the second pass artefact reduction method, thereby reducing artefacts in the first image.

The above aspects and embodiments will become apparent from and be elucidated with reference to the exemplary embodiments described hereinafter. Exemplary embodiments of the invention will be described in the following with reference to the following drawings:

### BRIEF DESCRIPTION OF THE DRAWINGS

FIG. 1 shows a block diagram of the method for reducing artefacts in an image acquired with a cone beam computed tomography apparatus using a second pass artefact reduction method according to the invention.

FIG. 2 shows a block diagram of a second pass artefact reduction method for reducing artefacts in an image acquired with a cone beam computed tomography apparatus.

FIG. 3 shows a block diagram of the method for reducing artefacts in an image acquired with a cone beam computed tomography apparatus using a second pass artefact reduction method according to an embodiment of the invention.

FIG. 4 shows a block diagram of the method for reducing artefacts in an image acquired with a cone beam computed tomography apparatus using a second pass artefact reduction method according to an embodiment of the invention.

FIG. 5 shows a schematic set-up of a cone beam computed tomography apparatus for reducing artefacts in an image using a second pass artefact reduction method according to the invention.

### DETAILED DESCRIPTION OF EMBODIMENTS

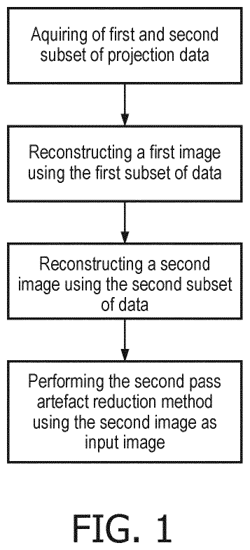

FIG. 1 shows a block diagram of the method for reducing artefacts in an image acquired with a cone beam computed tomography apparatus 100 using a second pass artefact reduction method according to the invention. In a first step, projection data of an object to be imaged with the cone beam computed tomography apparatus 100 is acquired in one or multiple acquisition scans. The projection data comprises a first subset of data 111 to be used for reconstruction of a first image 113, and a second subset of data 112 comprising projection data not to be used for the construction of the first image 113. The second subset of data 112 comprises projection data not comprised in the first subset of data 111. These projection data can be split in two parts with either data from separate scans or data from the same scan. In a second step, a first image 113 comprising a first resolution using the first subset of data 111 of the projection data is reconstructed, and in a third step, a second image 114 comprising a second resolution using the second subset of data 112 of the projection data is reconstructed. In a fourth step, the second pass artefact reduction method using the second image 114 as input image of the second pass artefact reduction method is performed, thereby reducing artefacts in the first image 113.

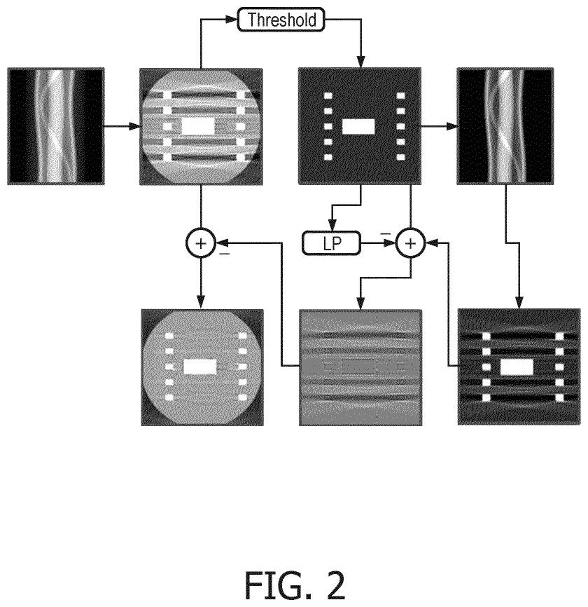

FIG. 2 shows a block diagram of a second pass artefact reduction method for reducing artefacts in an image acquired with a cone beam computed tomography apparatus. The second image 114 reconstructed from the second subset 112 of data can be used as input image for the second pass artefact reduction method. By applying a threshold to the input image, artefact inducing structures can be determined. These artefact inducing structures are forward projected resulting in virtual projection data that would have been detected by the computed tomography apparatus when imaging a phantom only comprising the artefact inducing structures. These virtual projection data are processed in order to reconstruct an image of the artefact inducing structures, for example by a filtered back projection. Therefore, this reconstructed image comprises, in addition to the reconstructed artefact inducing structures, the artefacts induced by the artefact inducing structures. By combining this artefact image with low-pass filtered data of the image of the artefact inducing structures, the artefacts can be isolated. This correction image only comprising the artefacts can be subtracted, preferably after appropriate registration and adjustment of the contrast, from the first image 113. Thus, a high-quality image of the first image 113 depicting the object to be imaged can be provided without being deteriorated by artefacts.

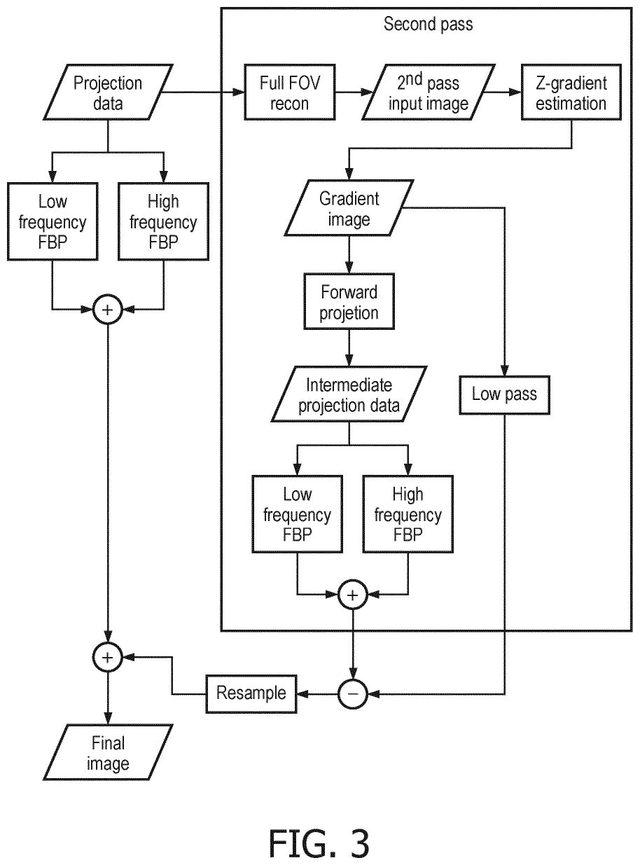

FIG. 3 shows a block diagram of the method for reducing artefacts in an image acquired with a cone beam computed tomography apparatus 100 using a second pass artefact reduction method according to an embodiment of the invention. The input image to the second pass estimation of the artefacts is replaced by an image that is not the image as it is originally reconstructed (cardiac FOV, gated reconstruction with frequency split). Rather it is a full FOV image obtained from a full FOV reconstruction using all data available. The input image to the second pass estimation uses full-scan data in order to maximize the z-extent of the input image, thus capturing as much of the artefact inducing structures as possible. Optionally, full-scan reconstruction is used only for the image parts where a short scan reconstruction is not possible. Under the assumption that most artefacts are present in the low frequency image, the filtered back projection FBP reconstruction used in the second pass is not necessarily the one used in the first pass (two recons with frequency split) but rather just one, low-frequency reconstruction. The cut-off frequency is not necessarily the same as in the first pass reconstruction. In this case, the low pass filter LP in the second pass method needs to be modified appropriately. The in-plane image resolution can then also be reduced accordingly to save computational effort when performing the second pass forward- and back-projections. In all cases the resulting residual (artefact image) needs to be resampled, assuming that the target resolution within the cardiac FOV, which should be completely reconstructable using the narrow gating window, is higher than what is or should be used for the full FOV reconstruction, being the input to the second pass. In case of strong heart motion, the frequency split method can also be applied beneficially to the full FOV reconstruction. For the narrow gating window (high frequency path of the frequency split method) an angular weighting function is used, for which the weights do not drop to zero but to a small value greater than zero. This results in a merge of high and low frequency images, where in the high frequencies the image using a narrow gating window (high time resolution) is preferred in the cardiac FOV (well covered by the views from the narrow gating window) and the full FOV image is preferred in regions that are only well covered by data from the wide gating window.

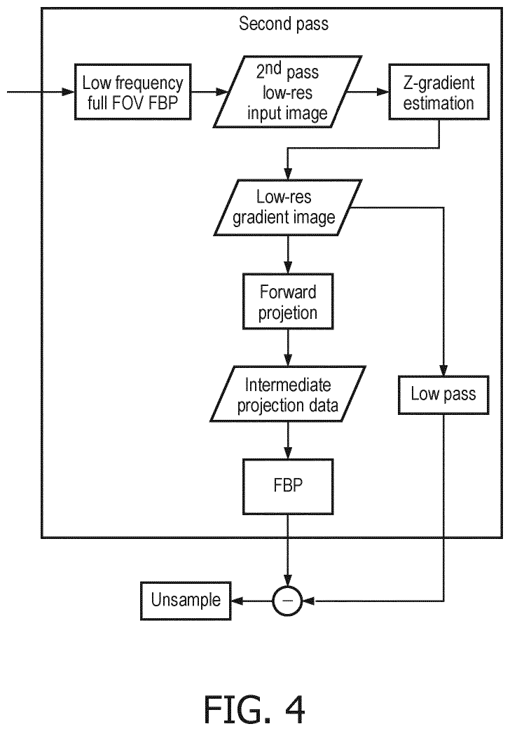

FIG. 4 shows a block diagram of the method for reducing artefacts in an image acquired with a cone beam computed tomography apparatus 100 using a second pass artefact reduction method according to an embodiment of the invention. The second pass artefact reduction method of FIG. 3 is performed with an input image comprising a lower resolution compared to the first image 113. Thus, the correction image is up-sampled before combined with the first image 113 to the final image comprising reduced artefacts.

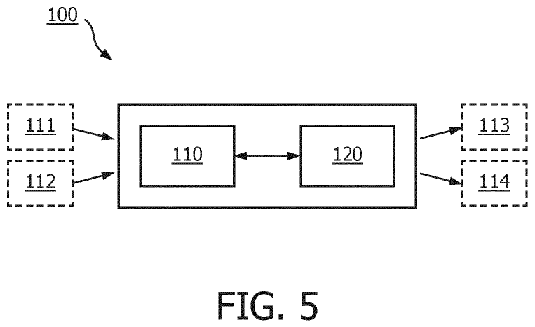

FIG. 5 shows a schematic set-up of a cone beam computed tomography apparatus 100 for reducing artefacts in an image using a second pass artefact reduction method according to the invention. The computed tomography apparatus 100 comprises an acquisition unit 110 for acquiring a first subset of data 111 and a second subset of data 112. The computed tomography apparatus 100 further comprises a processing unit 120 configured for controlling the acquisition unit and for reconstructing a first image 113 and a second image 114. The processing unit 120 is further configured for performing the second pass artefact reduction method with the second image as input image.

Provided a perfusion scan protocol that involves a time series of axial scans (perfusion scan) plus, ideally, one scan covering a larger region including the region for the perfusion scan (native scan), the method comprises: A registration method to register the volume image of the native scan to each of the volume images of the time series produced in the perfusion scan. If the native scan was performed at different tube settings (kVp), the image contrast needs to be adjusted to match the contrast of the perfusion scans. This can be easily done if the native scan is a dual energy scan. Usage of the registration parameters to determine the relative system-to-patient configuration. Given a relative system-to-patient configuration, any method to estimate cone-beam artefacts (residual image) for an axial cone-beam CT acquisition is performed, e.g. the second pass method described above. This is preferably done using the native scan volume. For this purpose, the native scan volume is warped onto the perfusion scan volume.

Further modifications/improvements:
1. In order to reduce computational burden, the artefacts are only estimated once for a specific system to patient configuration and the residual image is applied to all volumes of the perfusion scan time series.
2. If registration of the native scan is performed with respect to each image in the time series, the system-to-patient configuration can be tracked. This can be used to
a. e.g. use a mean of registration parameters to estimate a mean system to patient configuration for the estimation of the residual image.
b. to perform a number of residual image estimations as needed for significantly different system to patient configurations.
i. this can include some measure for significance
ii. plus possibly a clustering of deviations of system to patient configurations This may result in a number of residual images to be estimated smaller than the number of images in the time series from the perfusion scan.
c. correct registration of the residual image to each of the perfusion scan images in case of slight variations.
3. This method may or may not be performed using either the native scan image, a single or multiple images from the time series, the native scan promising best results. A different method for producing the correction image can be realized in the frequency domain without an explicit forward- and back projection procedure.
The second image is transformed into the frequency domain (FFT)
From the projection geometry and using the Fourier slice theorem a region in the Fourier domain is identified that contains the missing data, which has effectively not been measured during acquisition of the first image.
From this “missing data”, the correction image can be obtained by inverse FFT.
The region can be spatially varying, depending on the position in the image relative to the system geometry. Thus multiple inverse FFTs may need to be performed for different positions within or regions of the image.

In case one or both scans are spectral scans, the correction can be performed independently using the corresponding material basis image, using the same registration parameters, e.g. taken from registering the combined (conventional) or some basis material image. In case of spectral image acquisitions, mismatches between the images in terms of contrast (different keV setting, contrast medium present or not present), specific reconstructions, possibly differing from the diagnostic images, can be used for registration. One specific example: First and second scan may possibly be done at different keVs, a perfusion scan typically done at 80 keV (first scan), a typical native or CTA scan done at 120 keV (second scan). The keV mismatch results in different contrast levels in the images and may deteriorate registration results. In case, however, the second scan is a spectral scan, a virtually conventional image at the keV of the first scan can be reconstructed and used for registration instead of the diagnostic image. Another possibility could be to use a virtual non-contrast image in case the second scan is a CTA scan. Thus, a conventional image based on a kVp switching dual energy acquisition can be generated. This is based on an intermediate material decomposition followed by a re-composition at the desired conventional tube spectrum. The presence of a conventional image will improve customer acceptance of the dual energy acquisition protocol.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. The mere fact that certain measures are re-cited in mutually different dependent claims does not indicate that a combination of these measures cannot be used to advantage. Any reference signs in the claims should not be construed as limiting the scope.

### LIST OF REFERENCE SIGNS

100 cone beam computed tomography apparatus
110 acquisition unit
111 first subset of data
112 second subset of data
113 first image
114 second image
120 processing unit

1. A method for reducing artefacts in a cone beam computed tomography, the method comprising:
acquiring projection data of an object to be imaged, wherein the projection data comprises a first subset of data to be used for reconstruction of a first image, and a second subset of data comprising projection data not to be used for the construction of the first image, wherein the second subset of data comprises projection data not comprised in the first subset of data;
reconstructing a first image comprising a first resolution using the first subset of data of the projection data;
reconstructing a second image comprising a second resolution lower than the first resolution of the first image using the second subset of data of the projection data; and
performing a second pass artefact reduction using the second image as input image of the second pass artefact reduction such that artefacts in the first image are reduced.

2. The method according to claim 1, wherein the second subset of data comprises projection data from a region of the object that is not comprised in the first subset of data, or wherein the second subset of data comprises projection data of the object from a projection direction not comprised in the first subset of data.

3. The method according to claim 1, wherein the second pass artefact reduction comprises:
determining an artefact-inducing structure in the input image;
forward-projecting the artefact-inducing structure into forward projection data;
reconstructing an artefact image using the forward projection data;
combining the artefact image with a low pass filtered image of the artefact-inducing structure thereby generating a correction image; and
combining the correction image with the first image thereby reducing artefacts in the first image.

4. The method according to claim 3, wherein the artefact-inducing structure comprises a high absorption density gradient in a direction parallel to a rotation axis of a computed tomography apparatus.

5. The method according to claim 3, wherein the second pass artefact reduction comprises up-sampling the correction image to a resolution equal to the first resolution of the first image.

6. The method according to claim 1, wherein the second subset of data comprises data acquired in a second scan prior to a brain perfusion scan, or wherein the second subset of data comprises data acquired due to cardiac phase tolerances in a gated cardiac scan.

7. The method according to claim 6, wherein the second scan is a helical scan.

8. The method according to claim 1, wherein a second image contrast of the second image is adjusted to match a first image contrast of the first image.

9. The method according to claim 1, wherein the second image is registered to the first image.

10. The method according to claim 1, wherein the second image is low-pass filtered.

11. The method according to claim 1, wherein the reconstruction of the first image and/or the reconstruction of the second image comprises a frequency split.

12. A computed tomography apparatus for reducing cone beam artefacts in an image using a second pass artefact reduction, the apparatus comprising
an acquisition unit configured for acquiring projection data of an object to be imaged, wherein the projection data comprises a first subset of data to be used for reconstruction of a first image, and a second subset of data comprising projection data not to be used for the construction of the first image, wherein the second subset of data comprises projection data not comprised in the first subset of data; and
a processor configured for reconstructing a first image comprising a first resolution using the first subset of data of the projection data, wherein the processor is configured for reconstructing a second image comprising a second resolution lower than the first resolution of the first image using the second subset of data of the projection data, and configured for performing the second pass artefact reduction method using the second image as input image of the second pass artefact reduction method, thereby reducing artefacts in the first image.

13. The apparatus according to claim 12, wherein the processor is further configured to determine an artefact-inducing structure in the input image, to forward-project the artefact-inducing structure into forward projection data, reconstruct an artefact image using the forward projection data, combine the artefact image with a low pass filtered image of the artefact-inducing structure thereby generating a correction image, and combine the correction image with the first image thereby reducing artefacts in the first image.

14. (canceled)

15. (canceled)

16. A non-transitory computer-readable medium for storing executable instructions, which cause a method to be performed for reducing artefacts in a cone beam computed tomography, the method comprising:
acquiring projection data of an object to be imaged, wherein the projection data comprises a first subset of data to be used for reconstruction of a first image, and a second subset of data comprising projection data not to be used for the construction of the first image, wherein the second subset of data comprises projection data not comprised in the first subset of data;
reconstructing a first image comprising a first resolution using the first subset of data of the projection data;
reconstructing a second image comprising a second resolution lower than the first resolution of the first image using the second subset of data of the projection data; and
performing a second pass artefact reduction using the second image as input image of the second pass artefact reduction such that artefacts in the first image are reduced.
